(19) United States
(12) Patent Application Publication
(10) Pub. No.: US 2004/0186778 A1
(43) Pub. Date: Sep. 23, 2004

(54) Systems and methods for selecting advertisements to be provided to users via a communication network

(76) Inventors: William A. Margiloff, New York, NY (US); Keith M. Dallara, New York, NY (US); Christopher J. Hansen, Brooklyn, NY (US)

Correspondence Address: BUCKLEY, MASCHOFF, TALWALKAR LLC, 5 ELM STREET, NEW CANAAN, CT, 06840, US

(21) Appl. No.: 10/767,242

(22) Filed: Jan. 29, 2004

Related U.S. Application Data
(60) Provisional application No. 60/443,511, filed on Jan. 29, 2003.
(60) Provisional application No. 60/443,513, filed on Jan. 29, 2003.
(60) Provisional application No. 60/443,512, filed on Jan. 29, 2003.

(51) Int. Cl. G06F 17/60

(52) U.S. Cl. 705/14

(57) ABSTRACT

According to some embodiments, systems and methods are provided to select advertisements to be provided to users via a communication network.

### CROSS-REFERENCE TO RELATED APPLICATIONS

The present application claims priority under 35 U.S.C. § 119(e) to (i) U.S. Provisional Patent Application No. 60/443,511 entitled “Systems and Methods for Providing an Improved Toolbar,” (ii) U.S. Provisional Patent Application No. 60/443,513 entitled “Systems and Methods for Providing Locally Determined Contextual Advertising Information via a Communications Network,” and (iii) U.S. Provisional Patent Application No. 60/443,512 entitled “Systems and Methods For Selecting Graphical Advertisements To Be Provided To Users via a Communication Network,” all filed in the name of Margiloff et al. on Jan. 29, 2003. The present application is also related to (i) U.S. patent application Ser. No. __/___,___ entitled “Systems and Methods for Providing an Improved Toolbar” and (ii) U.S. patent application Ser. No. __/___,___ entitled “Systems and Methods For Providing Contextual Advertising Information via a Communication Network,” filed concurrently herewith. The entire contents of these applications are incorporated herein by reference.

### FIELD

The present invention relates to advertising information. In particular, the present invention relates to systems and methods for selecting advertisements to be provided to users via a communication network.

### BACKGROUND

It is known that an advertising service can select graphical advertisements to be displayed to a user (e.g., banner and pop-up advertisements). It is also known that graphical advertisements (or information associated with those advertisements) can be selected and transmitted to a remote user device for later display. In some cases, an advertising service may select a graphical advertisement and dynamically incorporate the advertisement into a Web page that is accessed by a user. In other cases, a local advertising application can execute at the user's Personal Computer (PC) while he or she accesses Web sites. The advertising application may, for example, display a particular advertisement to the user based on a Uniform Resource Locator (URL) address of a Web page that the user is currently viewing.

In some cases, different advertisers are willing to pay different amounts of money in exchange for the display of advertisements to users. For example, a first advertiser might be willing to pay three cents for every one thousand banner advertisements that are displayed, referred to as the cost-per-thousand value (CPM), while a second advertiser is only willing pay two cents CPM. In this case, the advertising service will typically want to select advertisements from the first advertiser more often than it does from the second advertiser (to increase revenue).

Some advertisers, however, may provide payment based on an action performed by a user (instead of for merely displaying an advertisement to the user). For example, an advertiser might pay five cents for every user that clicks on a particular graphical advertisement, referred to as the cost-per-click value (CPC).

As a result, the advertising service might not effectively increase revenue by simply selecting advertisements that have high CPC values (because if no users click on an advertisement the advertising service will receive no payment at all—no matter how high the CPC value). To avoid this, it is known that an operator can manually review CPC values and click-through-rates (CTR) to attempt to increase revenue. Such an approach, however, is time consuming and a significant amount of revenue might still be lost (e.g., due to operator error or delay), especially when there are a large number of advertisers, advertisements, and/or users involved. The approach may also be impractical when the advertisers, advertisements, and/or payment amounts change frequently.

An adverising server may, in some cases, select one of a number of different advertisements to be displayed to a user (e.g., an advertising service might select an advertisement based on a CPM value). It might be the case, however, that the selected advertisement should not be displayed to that particular user. For example, an advertisement might not be appropriate when the store being advertised does not currently have in stock the product the user is interested in and/or when another store is selling the item for a lower price.

Still another disadvantage of known advertising methods is that different advertisements need to be created for different advertisers. For example, a graphical banner advertisement created for CIRCUIT CITY® that includes the store's name, a price of a product at the store, and/or directions to the store cannot be used if another electronics store wanted to advertise to users. The cost and time required to create new advertisements may be impractical—especially when there are a significant number of frequently changing advertisers and/or the amounts being paid by the advertisers are relatively small.

### BRIEF DESCRIPTION OF THE DRAWINGS

FIG. 1 is a block diagram overview of a system according to some embodiments of the present invention.

FIG. 2 illustrates a user display according to some embodiments. of the present invention.

FIG. 3 is a flow chart of a method according to some embodiments of the present invention.

FIG. 4 is a portion of an advertisement database according to one embodiment of the present invention.

FIG. 5 is a portion of an advertisement database according to another embodiment of the present invention.

FIG. 6 is a block diagram of an advertising controller according to some embodiments of the present invention.

FIG. 7 illustrates a system according to another embodiment.

FIG. 8 is a method according to another embodiment.

FIG. 9 illustrates a user display according to another embodiment.

FIG. 10 is a system according to still another embodiment.

FIG. 11 is a method according to some embodiments.

FIG. 12 is a block diagram of a system according to another embodiment.

FIG. 13 is a flow chart of a method according to this embodiment.

FIG. 14 is a portion of a bidding database according to this embodiment.

### DETAILED DESCRIPTION

Some embodiments of the present invention are associated with a “graphical advertisement.” As used herein, the phrase “graphical advertisement” may refer to, for example, graphical information about a product or service, a coupon, or any other commercial information that is provided to a user (and may also include including text, animation, video, audio, and/or executable information). Examples of graphical advertisements include banner advertisements, interstitial advertisements (e.g., pop-up or pop-under), and hyperstitial advertisements (e.g., “full-page” advertisements).

System Overview

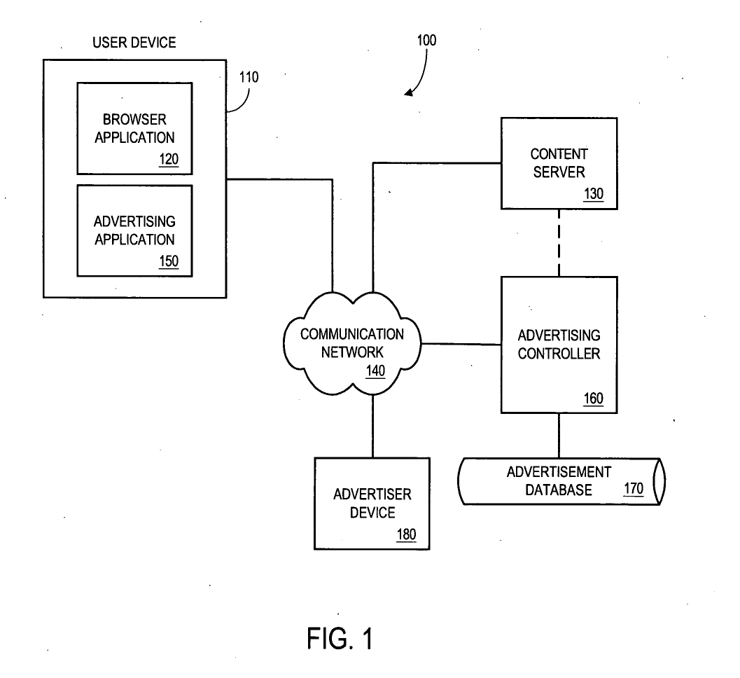

Turning now in detail to the drawings, FIG. 1 is a block diagram of a system 100 according to some embodiments of the present invention. In particular, a user device 110 executes a browser application 120 (e.g., the INTERNET EXPLORER® browser application available from MICROSOFT®) that accesses information from a content server 130.

As used herein, devices (such as the user device 110 and the content server 130) may communicate via a communication network 140, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the user device 110 may only communicate with the content server 130 on an as-needed basis. In some embodiments, for example, the user device 110 may be a PC that intermittently utilizes a dial-up connection to the Internet via an Internet Service Provider (ISP). In other embodiments the user device 110 may be in constant and/or high-speed communication with the content server 130 through the use of any known or available connection device such as a cable or Digital Subscriber Line (DSL) modem. According to some embodiments, the communication network 140 may be or include multiple networks of varying type, configuration, size, and/or functionality.

Although a single user device 110 and a single content server 130 are illustrated in FIG. 1, any number of these devices may be included in the system 100. Similarly, any number of the other devices described herein may be included in the system 100 according to embodiments of the present invention. A single content server 130 may, for example, be in communication with multiple user devices 110. In some embodiments, multiple content servers 130 may provide various information such as advertisements and/or web pages to one or more user device 110.

The user device 110 and the content server 130 may be any devices capable of performing various functions described herein. The user device 110 may be, for example: a PC, a portable computing device such as a Personal Digital Assistant (PDA), an interactive television device, or any other appropriate storage and/or communication device. The content server 130 may be, for example, a Web server that provides web pages for the browser application 120.

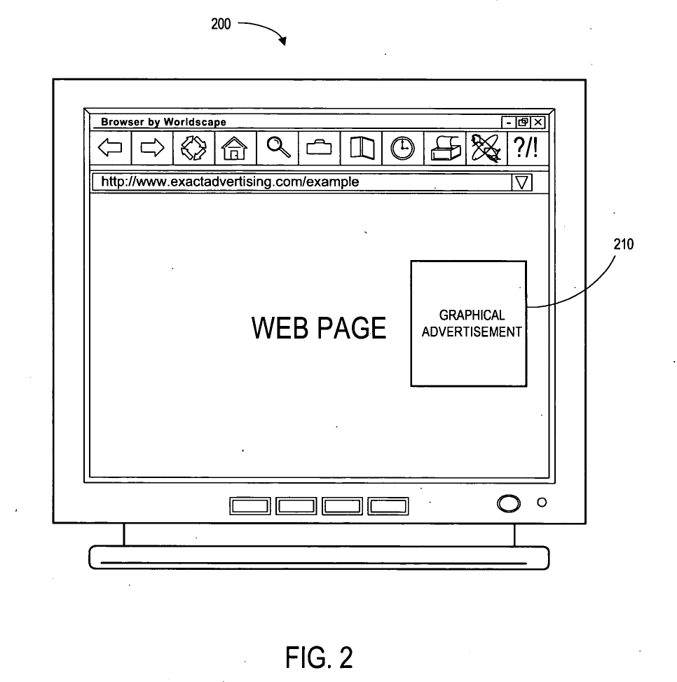

According to some embodiments described herein, a graphical advertisement is transmitted to the user device 110. For example, the content server 130 might receive advertising information from an advertising controller 160 and incorporate that information into a Web page. FIG. 2 illustrates a user display 200 including a graphical advertisement 210 according to some embodiments of the present invention. According to another embodiment, the content server 130 transmits to the browser application 110 a pointer associated with the advertising information (e.g., a URL address). The browser application 120 can then retrieve the advertising information directly from the advertising controller 160 and display it to the user.

According to other embodiments, information about an advertisement is provided to the user device 110 well before it is displayed to the user (e.g., the information might be downloaded to the user device 110 on a nightly basis and displayed to the user during the day—even when the user device 110 is not attached to the communication network 140).

For example, the user device 110 might execute an advertising application 150 (e.g., previously installed by the user) that receives advertising information from the advertising controller 160. This information might include advertisement content and an associated advertisement rule—such as a rule indicating that a particular advertisement should be displayed whenever a user searches for the word “tires” via a search engine. The advertisement content might represent information that can be used by the advertising application 150 to access the advertisement (e.g., by downloading a file from the advertising controller 160 or from another advertiser device 180).

Advertising Controller Method

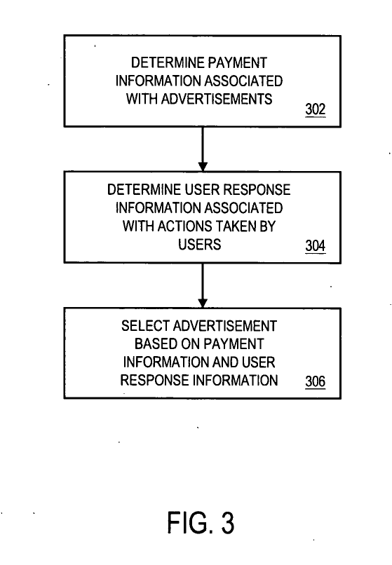

FIG. 3 is a flow chart of a method according to some embodiments of the present invention. The flow charts in FIG. 3 and the other figures described herein do not imply a fixed order to the steps, and embodiments of the present invention can be practiced in any order that is practicable. The method shown in FIG. 3 may be performed, for example, by the advertising controller 160.

At 302, payment information is determined for a number of different advertisements. For example, the advertising controller 160 might receive payment information from a number of advertiser devices 180. Note that different advertisements might be associated with different advertisers.

Consider graphical advertisements such as Web site banner and “pop-up” advertisements. In this case, the payment information might comprise a cost-per-click value (e.g., an advertiser might be willing to pay two cents for each user who clicks on a banner advertisement). As another example, the payment information might comprise a cost-per-action value (e.g., an advertiser might be willing to pay fifty cents for each user who registers with a Web site in response to the graphical advertisement).

At 304, user response information is determined for each advertisement. For example, the advertising controller 160 or an advertiser device 180 might determine the user response information based on actions taken by users in response to advertisements—such as a click-through-rate value representing how often users clicked on a pop-up advertisement. As another example, the user response information might comprise a user purchase frequency representing how often users purchased a product or service in response to a banner advertisement.

At 306, at least one of the advertisements is selected based on the payment information and the user response information. For example, an advertisement might be selected based on its cost-per-click value multiplied by its click-through-rate value. Note that this selection might not be based, according to some embodiments, on information received from a remote user device 110 (e.g., the advertisement might be selected without regard to information received from the user via a Web site).

The selected advertisement may then be displayed to the user (e.g., information about the advertisement may be transmitted to his or her remote user device 110). According to some embodiments, the remote user device 110 locally determines when the advertisement will be displayed (e.g., via an advertising application 150 that evaluates contextual information being accessed by a user). According to some embodiments, the graphical advertisement is displayed to the user via a toolbar (e.g., to help the user recognize that the advertisement is not being provided by the Web site he or she is currently viewing).

Advertisement Database Examples

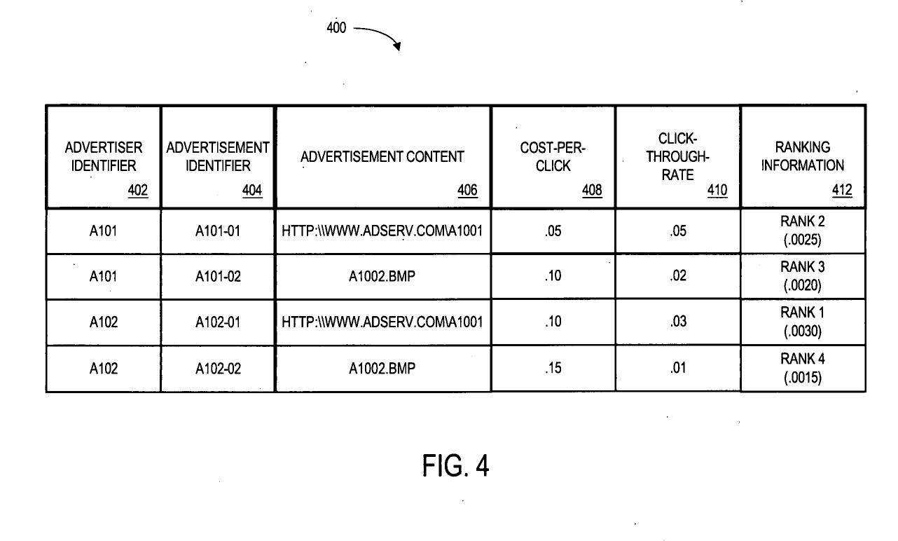

Referring to FIG. 4, a table represents an advertisement database 400 that may be stored at the advertising controller 160 according to an embodiment of the present invention. The table includes entries identifying graphical advertisements that might be provided to a user. The table also defines fields 402, 404, 406, 408, 410, 412 for each of the entries. The fields specify: an advertiser identifier 402, an advertisement identifier 404, advertisement content 406, a cost-per-click 408, a click-through-rate 410, and ranking information 412. The information in the advertisement database 400 may be created and updated, for example, based on information received from a content server 130, an advertiser device 180, and/or user devices 110 (e.g., on a nightly basis).

The advertiser identifier 402 may be, for example, an alphanumeric code associated with an advertiser who wants to provide graphical advertisements to users. The advertisement identifier 404 may be, for example, an alphanumeric code associated with a graphical advertisement that might be displayed to a user. The advertisement content 406 might comprise, for example, a pointer indicating where advertisement information can be retrieved from or the information itself (perhaps including text, animation, video, audio, and/or executable information).

The cost-per-click 408 is a value representing an amount of money the advertiser is willing to pay each time a user clicks on the advertisement. For example, the advertiser associated with “A101” will pay five, cents each time a user clicks on advertisement “A101-01.” The click-through-rate 410 is a value representing how often users click on the advertisement (e.g., during the lifetime of the advertisement or during a pre-determined period, such as the last three days). For example, five out of every one hundred users click on advertisement “A101-01.” According to some embodiments, a default click-through-rate value is provided when no actual data is available (e.g., for a newly created advertisement).

The ranking information 412 is based on the cost-per-click 408 and the click-through-rate 410 and may be used by the advertising controller 160 to select which advertisement(s) will be provided to users. As illustrated in FIG. 4, the ranking information 412 may represent the cost-per-click 408 multiplied by the actual click-through-rate 410. As a result, a first advertisement with a higher cost-per-click 408 as compared to a second advertisement may still have lower ranking information 412. For example, advertisement “A102-02” (with a cost-per-click 408 of fifteen cents) is ranked fourth while advertisement “A101-01” (with a cost-per-per-click 408 of five cents) is ranked second. This is because the click-through-rate 410 associated with advertisement “A101-01” is so much higher as compared to advertisement “A102-02.” In this way, the revenue collected by the advertising controller 160 may be improved.

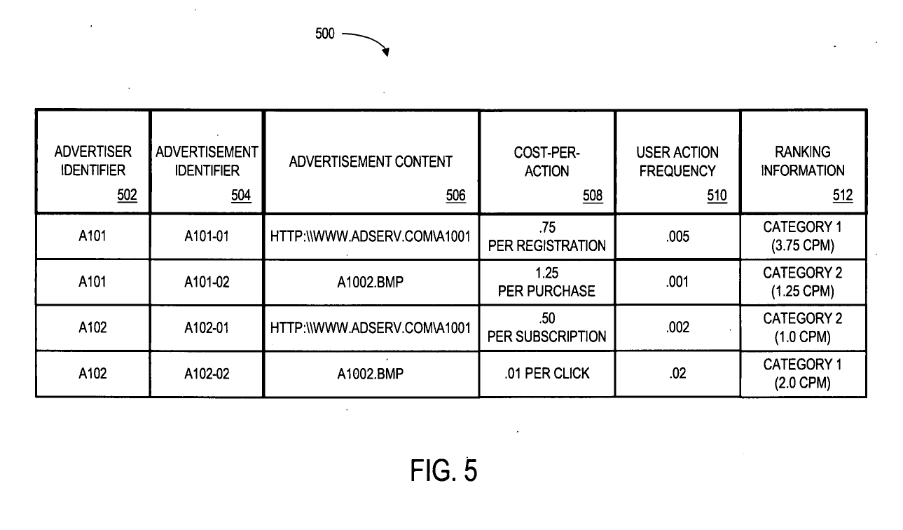

Referring now to FIG. 5, a table represents an advertisement database 500 that might be stored at the advertising controller 160 according to another embodiment of the present invention. Again, the table includes entries identifying graphical advertisements that might be provided to a user. The table also defines fields 502, 504, 506, 508, 510, 512 for each of the entries. The fields specify: an advertiser identifier 502, an advertisement identifier 504, advertisement content 506, a cost-per-action 508, a user action frequency 510, and ranking information 512. The information in the advertisement database 500 may be created and updated, for example, based on information received from a content server 130, an advertiser device 180, and/or user devices 110.

The cost-per-action 508 is a value representing an amount of money the advertiser is willing to pay each time a user performs some action in response to a graphical advertisement. By way of example, the action performed by the user might comprise: (i) clicking on the advertisement, (ii) registering with a Web site or service, (iii) purchasing a product or service, or (iv) subscribing to a service. For example, the advertiser “A101” will pay seventy five cents each time a user registers with an associated Web site. The user action frequency 510 is a value representing how often users perform the action. For example, two out of every one thousand users will (on average) subscribe to a newsletter in response to advertisement “A102-01.”

The ranking information 512 is based on the cost-per-action 508 and the user action frequency 510 and may be used by the advertising controller 160 to select which advertisement(s) will be provided to users. As illustrated in FIG. 5, the ranking information 512 may represent the cost-per-action 508 multiplied by the user action frequency 510. As a result, an advertisement with a higher cost-per-action 508 could have a rank worse than another advertisement with a lower cost-per-action 508.

Note that the ranking information 512 does not need to be a simply numerical ranking order. For example, as illustrated in FIG. 5, different advertisements might be placed into different categories (e.g., and advertisements may be selected from different categories at different frequencies). As another approach, the ranking information 512 might represent a weighing factor used in a random advertisement selection process.

Also note that the ranking information 512 may represent an effective CPM for the advertisement. In this way, an advertising controller 160 could select from among advertisements that are associated with CPM values, cost-per-click values, and/or cost-per-action values.

Advertising Controller

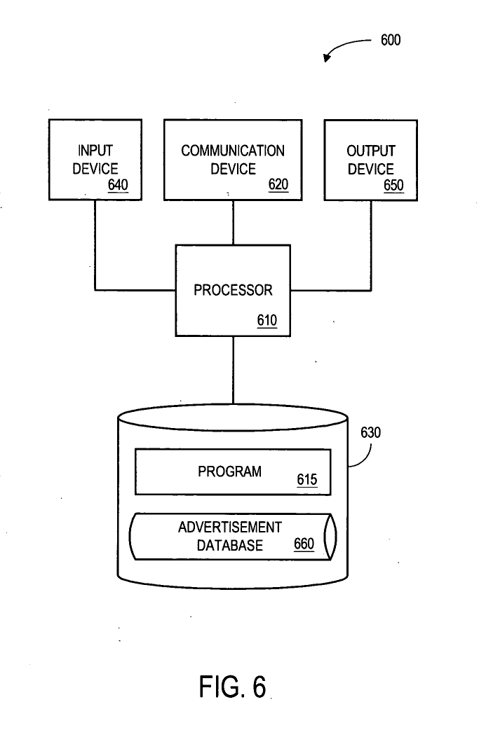

FIG. 6 illustrates an advertising controller 600 that is descriptive of the device shown in FIG. 1 according to an embodiment of the present invention. The advertising controller 600 comprises a processor 610, such as one or more INTEL® Pentium® processors, coupled to a communication device 620 configured to communicate via a communication network (not shown in FIG. 6). The communication device 620 may be used to communicate, for example, with one or more user devices 110, content servers 130, and/or advertiser devices 180. The user device 600 further includes an input device 640 (e.g., a mouser and/or keyboard) and an output device 650 (e.g., a computer monitor).

The processor 610 communicates with a storage device 630. The storage device 630 may comprise any appropriate information storage device, including combinations of magnetic storage devices (e.g., a hard disk drive), optical storage devices, and/or semiconductor memory devices such as Random Access Memory (RAM) devices and Read Only Memory (ROM) devices.

The storage device 630 stores a program 615 for controlling the processor 610. The processor 610 performs instructions of the program 615, and thereby operates in accordance with any of the embodiments described herein. For example, the processor 610 may select graphical advertisements to be displayed to a user based on information stored in an advertisement database 660.

The program 615 may be stored in a compressed, uncompiled and/or encrypted format. The program 615 may furthermore include other program elements, such as an operating system, a database management system, and/or device drivers used by the processor 610 to interface with peripheral devices.

As used herein, information may be “received” by or “transmitted” to, for example: (i) the advertising controller 600 from another device; or (ii) a software application or module within the advertising controller 600 from another software application, module, or any other source.

Indication of an Advertisement Category

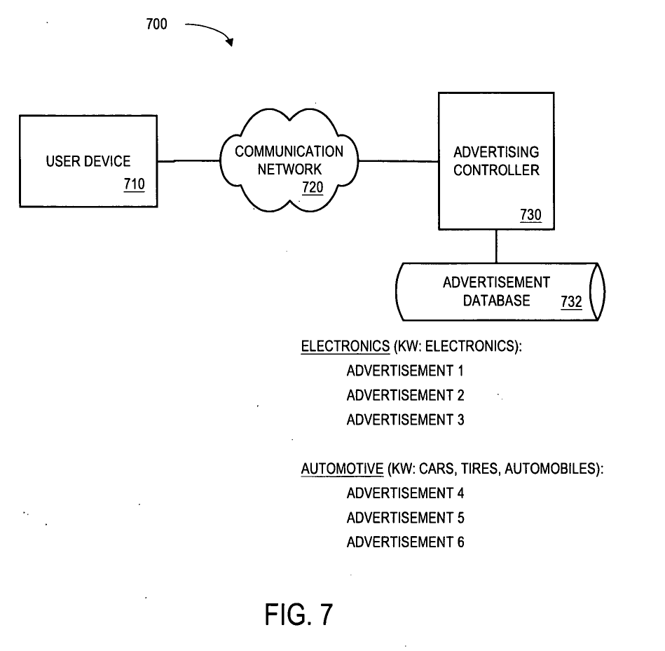

FIG. 7 illustrates a system 700 according to another embodiment. As before, a user device 710 receives information from an advertising controller 730 via a communication network 720 (e.g., while accessing remote web sites). Note that the devices and/or methods of exchanging information may be performed in accordance with other embodiments described herein or in any other way.

The advertising controller 730 receives information from a advertisement database 732. In particular, the advertisement database 732 stores information associated with a number of product “categories.” For example, the advertisement database 732 may store information about an “electronics” product category, including a keyword associated with that category (e.g., “electronics”) as well as a number of different advertisements associated with that category (e.g., advertisements 1 through 3). Similarly, the advertisement database 732 may store information about an “automotive” product category, including several different keywords associated with that category (e.g., “cars,” “tires,” and “automobiles”) as well as a number of different advertisements associated with that category (e.g., advertisements 4 through 6).

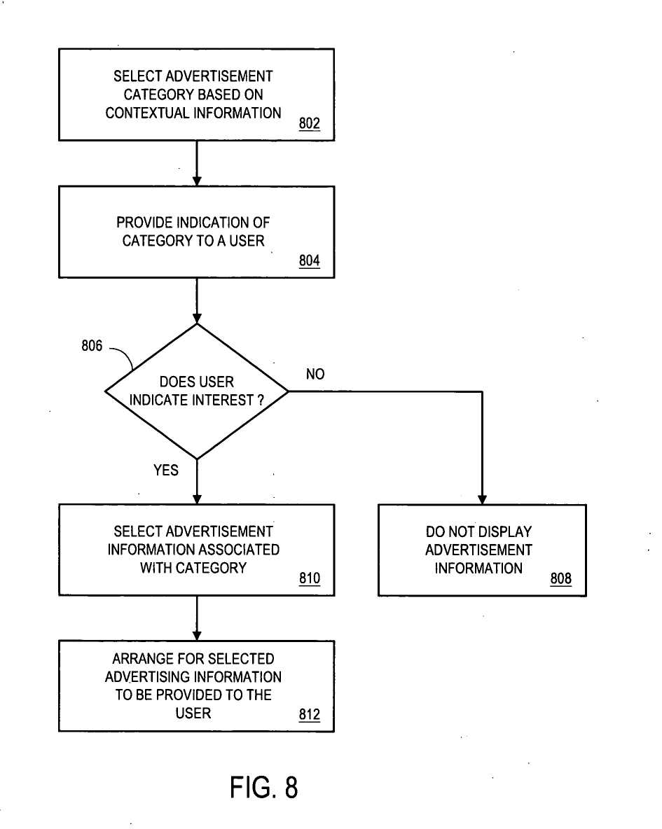

FIG. 8 is a method according to this embodiment. At 802, an advertisement category is selected based on contextual information (e.g., associated with remote information being accessed by a user). For example, a “hotel” or “travel” advertisement category might be selected when a user types “hotels” into a search bar. Similarly, the contextual information might be related to a keyword that appears on a web page, a URL, audio information, and/or graphical information (e.g., when a picture of an automobile is displayed to a user).

At 804, an indication of the advertisement category is provided to the user (e.g., a text, graphical, and/or audio indication). According to this embodiment, the indication of the advertisement category does not identify an advertiser. For example, a banner advertisement that simply says “click here for a great travel offer” might be displayed to the user. Note that an advertisement category might be based on product information, retailer information, and/or user information.

At 806, an indication may be received from the user. If no indication is received from the user, no advertisement information is displayed at 808. If an indication of interest is received from the user (e.g., he or she clicks on the banner advertisement), advertisement information associated with that advertisement category is selected at 812. The selection may be based on, for example, a bid amount (e.g., a retailer who provides a relatively high bid to an advertising service might be selected), a payment amount, a random process, a round robin process, and/or user information.

It is then arranged for advertising information associated with a particular advertiser to be provided to the user at 812. For example, the user may be taken to an automotive web site. Note that the advertising information might include text, audio, and/or graphical information.

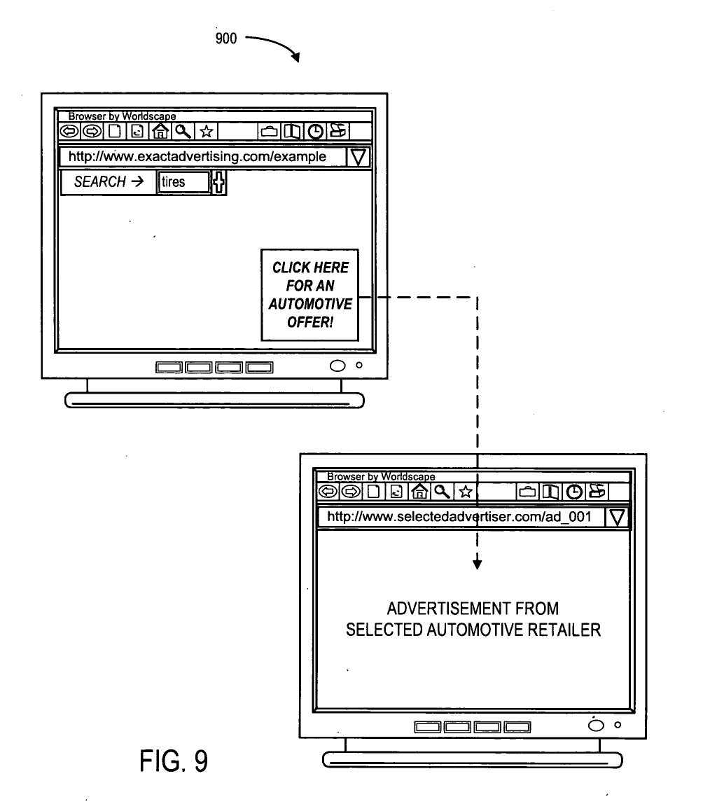

FIG. 9 illustrates a user display 900 according to another embodiment. In this case, the user has entered “tires” into a search bar. As a result, an icon appears stating “Click Here for an Automotive Offer!” If the user activates the icon (as illustrated by a dashed arrow in FIG. 9), an advertisement from a selected automotive retailer is automatically displayed to the user (e.g., he or she does not need perform any other action).

Note that that the original icon does not indicate a particular product or advertiser. In this way, an advertising service might be able to provide advertising information from a relative large number of frequently changing retailers without needing to continually create new icons.

Selecting a Potential Advertiser Based on Product Information

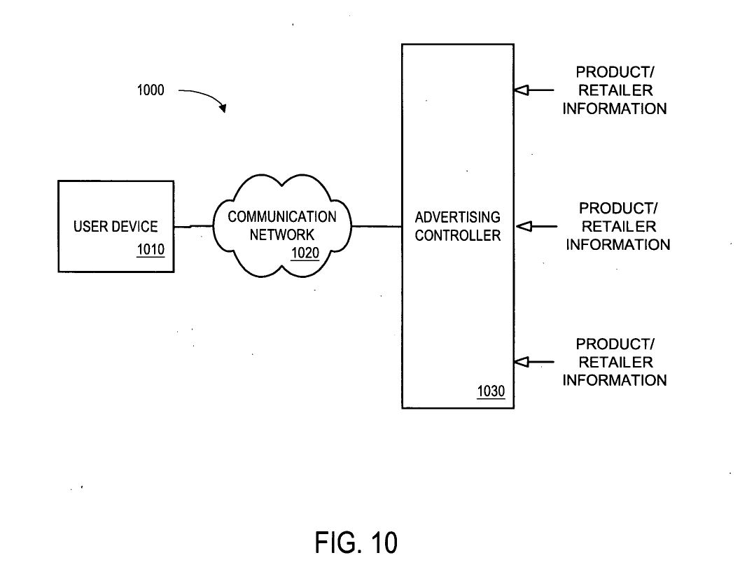

FIG. 10 is a system 1000 according to still another embodiment. As before, a user device 1010 receives information from an advertising controller 1030 via a communication network 1020 (e.g., while accessing remote web sites). Note that the devices and/or methods of exchanging information may be performed in accordance with other embodiments described herein or in any other way.

The advertising controller 1030 receives product and/or retailer information form a number of different sources. For example, the advertising controller 1030 may receive information indicating the price a user would have to pay in order to download a particular song from a number of different online music retailers.

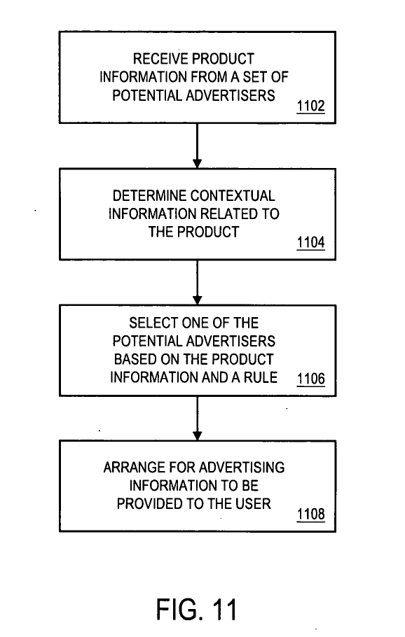

FIG. 11 is a method according to this embodiment. At 1102, product information is received from a set of potential advertisers associated with a product. The product information might include, for example, a product price, a product quality (e.g., a restaurant rating), and/or a product availability (e.g., indicating whether a particular computer model is currently in stock). Note that the product information may be received via a periodic process (e.g., once per day), a batch process, and/or a process performed in response to a determination of contextual information.

At 1104, it is determined that contextual information is related to the product, the contextual information being associated with remote information being accessed by a user. For example, when a user accesses a web page that includes the key phrase “wireless service” it might be determined that the context of the web page is associated with a VERIZON® subscription plan. Similarly, the contextual information might be related to a search term, a URL, audio information, and/or graphical information.

At 1106, one of the potential advertisers is selected based on the product information and a rule associated with the product. For example, an advertising controller 1030 might always select the potential advertiser that sells a product at the lowest price.

According to some embodiments, advertising information is then dynamically constructing in substantially real time. For example, advertising components, including an indication that this advertiser is selling the item at the lowest price as of a particular date, might be aggregated to create a graphical advertisement. This may be performed in response the selection at 1106 or at any other time.

It is then arranged for advertising information (e.g., a text or graphical advertisement that was created based on the product information) associated with the selected advertiser to be provided to the user at 1108. Note that according to some embodiments, retailer information is used instead of, or addition to, the product information (e.g., the retailer information might indicate that the retailer has the average lowest price for a particular type of product).

Bidding Engine

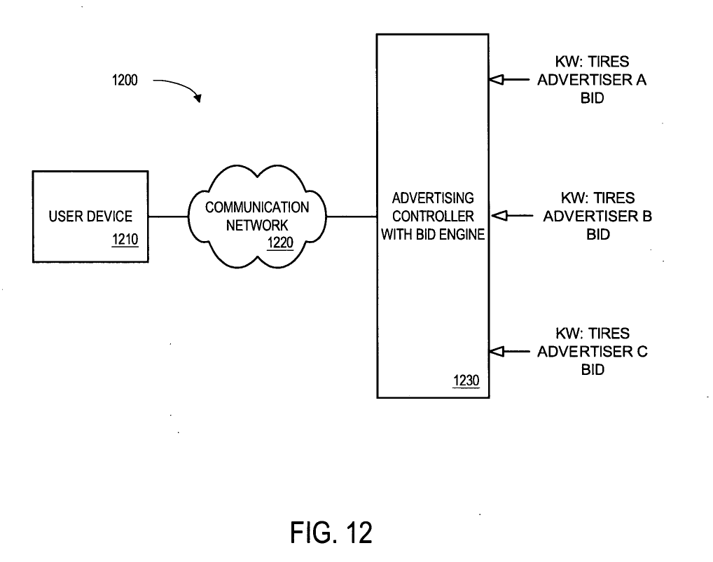

FIG. 12 is a block diagram of a system 1200 according to another embodiment. As before, a user device 1210 may receive information from an advertisement controller 1230 via a communication network 1220. Note that the devices and/or methods of exchanging information may be performed in accordance with other embodiments described herein or in any other way.

According to this embodiment, the advertising controller 1230 further includes a bid engine that receives bid amounts from a number of different advertisers. For example, a first advertiser might indicate that it is willing to pay $0.03 for each advertisement that is displayed to a user. According to some embodiments, the advertiser also provides graphical advertisement information to the advertising controller 1230 (e.g., as an image file or a pointer to a web page). The bid amounts may be further associated with contextual information. For example, a bid amount might indicate that the advertiser is willing to pay $0.03 when an advertisement is displayed to a user who has entered the word “hotels” into a search engine. Note that multiple keywords might be associated with a bid.

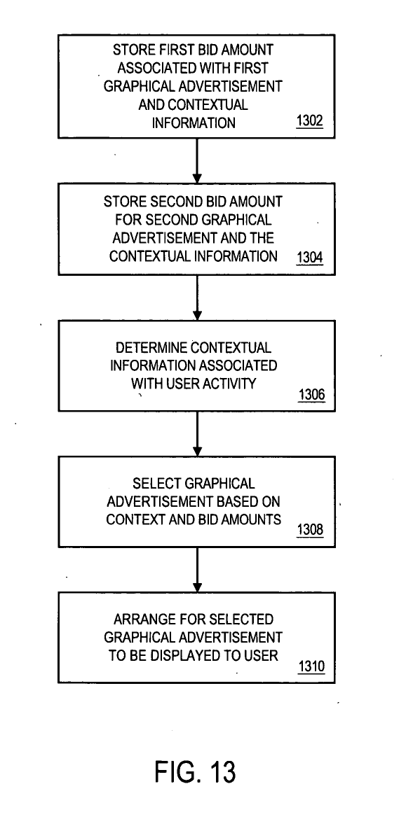

FIG. 13 is a flow chart of a method that might be performed by the advertising controller 1230 according to this embodiment. At 1302, a first bid amount is stored associated with a first graphical advertisement and contextual information. Similarly, a second bid amount is stored associated with a second graphical advertisement and the contextual information at 1304. The bid amounts may be, for example, received from different advertisers and/or different advertiser devices (e.g., via an advertising service Web site). Note that the bid amounts might be associated with a cost per advertisement displayed to a user and/or a cost per user action (e.g., a CPC amount).

At 1306, contextual information is determined associated with remote information being accessed by a user. For example, an application running locally at a user device might determine the contextual information based on a keyword, a search term, a URL, and/or a mouse position.

One of the first and second graphical advertisements are then selected at 1308 based on the first bid amount, the second bid amount, and the contextual information. For example, when a user accesses a Web page that includes an image having the word “auto” in the image file name, an advertising controller might select the advertisement that (i) is associated with the keyword “auto” and (ii) has the highest bid amount.

The selection performed at 1308 may be further based on an advertisement rule. For example, in some cases an advertisement with a lower bid amount might be selected (e.g., an advertisement with a higher bid amount might be more like likely, but not guaranteed, to be selected). The selection might also be based, according to some embodiments, on supplemental information associated with the user. For example, the supplemental information might be associated with geographic information, user device information, and/or other advertisements that have been displayed to the user.

At 1310, it is arranged for the selected graphical advertisement to be displayed to the user. For example, a pop-up advertisement might be displayed on the user's computer monitor. In some cases, the graphical advertisement may be provided to the user in substantially real time. In other cases, the graphical advertisement may be provided to a user device via a communication network and then be displayed to the user when the user device is not communicating via the communication network.

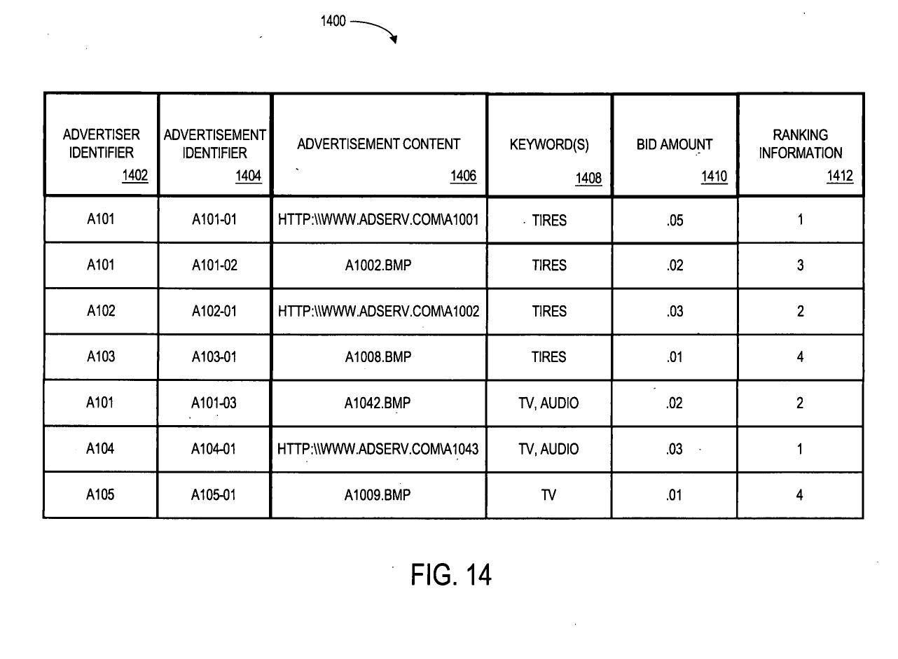

Referring to FIG. 14, a table represents an advertisement database 1400 that may be stored at the advertising controller 1230 according to this embodiment. The table includes entries identifying graphical advertisements that might be provided to a user. The table also defines fields 1402, 1404, 1406, 1408, 1410, 1412 for each of the entries. The fields specify: an advertiser identifier 1402, an advertisement identifier 1404, advertisement content 1406, one or more keywords 1408, a bid 1410, and ranking information 1412. The information in the advertisement database 1400 may be created and updated, for example, based on information received from advertisers.

The advertiser identifier 1402 may be, for example, an alphanumeric code associated with an advertiser who wants to provide graphical advertisements to users. The advertisement identifier 1404 may be, for example, an alphanumeric code associated with a graphical advertisement that might be displayed to a user. The advertisement content 1406 might comprise, for example, a pointer indicating where advertisement information can be retrieved from or the graphical information itself.

The bid amount 1410 represents an amount the advertiser is willing to pay to have the advertisement displayed to a user. According to other embodiments, the bid amount 1410 is a cost per user action, such as a CPC value representing an amount of money the advertiser is willing to pay each time a user clicks on the advertisement.

The ranking information 1412 is based on the bid amount 1410. For example, the first four entries in the database 1400 are associated with the keyword “tires.” In this case, advertisement A101 is ranked first because it is associated with the highest bid amount 1410. As a result, that advertisement might be selected and displayed to a user who enters the word “tires” into a search engine. According to some embodiments, advertisers can view their current ranking information 1412. Moreover, an advertiser might be able view ranking information 1412 and/or bid amounts 1410 associated with other advertisers (e.g., via an advertising service Web site).

The present invention has been described in terms of several embodiments solely for the purpose of illustration. Persons skilled in the art will recognize from this description that the invention is not limited to the embodiments described.

What is claimed is:

1. A method, comprising:
determining payment information associated with a plurality of graphical advertisements to be electronically provided to users via a communication network, the advertisements being associated with a number of different advertisers;
determining user response information for each advertisement, the user response information being associated with an action taken by a user in response to an advertisement; and
selecting at least one of the advertisements based on the payment information and the user response information.

2. The method of claim 1, wherein the selection of the advertisement is not based on information received from a remote user device.

3. The method of claim 1, wherein the communication network is the Internet, the action by the user is clicking on the advertisement, the payment information is a cost-per-click value, and the user response information is a click-through-rate value.

4. The method of claim 3, wherein said selecting comprises:
selecting the advertisement based on the cost-per-click value multiplied by the click-through-rate value.

5. The method of claim 1, the communication network is the Internet, the action by the user is a purchase, the payment information is a cost-per-action value, and the user response information represents a user purchase frequency.

6. The method of claim 1, further comprising:
displaying the selected advertisement to a user.

7. The method of claim 1, further comprising:
transmitting information about the advertisement to a remote user device.

8. The method of claim 1, wherein the remote user device locally determines when the advertisement will be displayed.

9. The method of claim 8, wherein the determination by the remote user device is based on contextual information associated with information being accessed by a user.

10. An apparatus, comprising:
a processor; and
a storage device in communication with said processor and storing instructions adapted to be executed by said processor to:
determine payment information associated with a plurality of graphical advertisements to be electronically provided to users via a communication network, the advertisements being associated with a number of different advertisers;
determine user response information for each advertisement, the user response information being associated with an action taken by a user in response to an advertisement; and
select at least one of the advertisements based on the payment information and the user response information.

11. A medium storing instructions adapted to be executed by a processor to perform a method, said method comprising:
determining payment information associated with a plurality of graphical advertisements to be electronically provided to users via a communication network, the advertisements being associated with a number of different advertisers;
determining user response information for each advertisement, the user response information being associated with an action taken by a user in response to an advertisement; and
selecting at least one of the advertisements based on the payment information and the user response information.

12. A method, comprising:
storing a first bid amount associated with a first graphical advertisement and contextual information;
storing a second bid amount associated with a second graphical advertisement and the contextual information;
determining contextual information associated with remote information being accessed by a user;
selecting one of the first and second graphical advertisements based on the first bid amount, the second bid amount, and the contextual information; and
arranging for the selected graphical advertisement to be displayed to the user.

13. The method of claim 12, wherein the first bid amount is received from a first advertiser and the second bid amount is received from a second advertiser.

14. The method of claim 12, wherein said selecting is further based on an advertisement rule.

15. The method of claim 12, wherein bid amount is associated with at least one of: (i) a cost per advertisement and (ii) a cost per user action.

16. The method of claim 12, wherein said determining is performed locally at a user device.

17. The method of claim 16, wherein the contextual information comprises at least one of: (i) a keyword, (ii) a search term, and (iii) uniform resource locator information.

18. The method of claim 12, wherein said selecting is further based on supplemental information associated with the user.

19. The method of claim 18, wherein the supplemental information is associated with at least one of: (i) geographic information, (ii) user device information, and (iii) other advertising information that has been provided to the user.

20. The method of claim 12, wherein the graphically advertisement is transmitted to a user device via a communication network and is displayed to the user when the user device is not communicating via the communication network.

21. A method, comprising:
selecting an advertisement category based on contextual information associated with remote information being accessed by a user;
providing an indication of the advertisement category to the user, wherein the indication of the advertisement category does not identify an advertiser;
receiving from the user an indication that the user is interested in the advertisement category; and
arranging, in response to the indication received from the user, for advertising information associated with a particular advertiser to be provided to the user.

22. The method of claim 21, wherein the contextual information comprises at least one of: (i) a keyword, (ii) a search term, and (iii) uniform resource locator information.

23. The method of claim 22, wherein a plurality of keywords are associated with a single advertisement category.

24. The method of claim 21, further comprising:
selecting the particular advertiser from a plurality of potential advertisers.

25. The method of claim 21, wherein said selecting is associated with at least one of: (i) a bid amount, (ii) a payment amount, (iii) a random process, (iv) a round robin process, and (v) user information.

26. The method of claim 21, wherein the indication provided to the user comprises at least one of: (i) a text indication, and (ii) a graphical indication.

27. The method of claim 21, wherein the advertising information comprises at least one of: (i) a text advertisement, and (ii) a graphical advertisement.

28. An apparatus, comprising:
a processor; and
a storage device in communication with said processor and storing instructions adapted to be executed by the processor to:
select an advertisement category based on contextual information associated with remote information being accessed by a user;
provide an indication of the advertisement category to the user, wherein the indication of the advertisement category does not identify an advertiser;
receive from the user an indication that the user is interested in the advertisement category; and
arrange, in response to the indication received from the user, for advertising information associated with a particular advertiser to be provided to the user.

29. A medium storing instructions adapted to be executed by a processor to perform a method, said method comprising:
selecting an advertisement category based on contextual information associated with remote information being accessed by a user;
providing an indication of the advertisement category to the user, wherein the indication of the advertisement category does not identify an advertiser;
receiving from the user an indication that the user is interested in the advertisement category; and
arranging, in response to the indication received from the user, for advertising information associated with a particular advertiser to be provided to the user.

30. A method, comprising:
receiving product information from a set of potential advertisers associated with a product;
determining that contextual information is related to the product, the contextual information being associated with remote information being accessed by a user;
selecting one of the potential advertisers based on the product information and a rule associated with the product; and
arranging for advertising information associated with the selected advertiser to be provided to the user.

31. The method of claim 30, wherein the product information comprises at least one of: (i) a product price, (ii) a product quality, (iii) a product availability.

32. The method of claim 30, wherein the advertising information comprises at least one of: (i) a text advertisement, and (ii) a graphical advertisement.

33. The method of claim 30, further comprising:
dynamically constructing the advertising information in substantially real time.

34. The method of claim 33, wherein said constructing comprises aggregating advertising components.

35. The method of claim 30, wherein said receiving comprises at least one of: (i) a periodic process, (ii) a batch process, and (iii) a process performed in response to a determination of contextual information.
